(19) United States
(12) Patent Application Publication
(10) Pub. No.: US 2019/0124834 A1
(43) Pub. Date: May 2, 2019

(54) CUTTING MONOFILAMENT FOR A VEGETATION CUTTING MACHINE AND PROCESS OF MANUFACTURING SUCH A MONOFILAMENT

(71) Applicant: Speed France SAS, Arnas (FR)

(72) Inventor: Emmanuel LEGRAND, St. Germain Sur Renon (FR)

(21) Appl. No.: 16/234,092

(22) Filed: Dec. 27, 2018

Related U.S. Application Data
(63) Continuation of application No. 14/497,097, filed on Sep. 25, 2014, now abandoned.

(30) Foreign Application Priority Data
Mar. 26, 2014 (EP) 14305431.0

(51) Int. Cl. A01D 34/416; B29C 48/05; B29K 77/00; B29L 31/00

(52) U.S. Cl. CPC A01D 34/4168; B29L 2031/731; B29K 2077/00; B29C 48/05

(57) ABSTRACT

The invention relates to a cutting monofilament (1) for a vegetation cutting machine such as a brush cutter or an edge trimmer, having a cross-section comprising at least two portions (10, 11, 12) made of thermoplastic materials having different mechanical properties, said cross-section being constant along a longitudinal axis (X) of the monofilament, wherein each of said portions (10, 11, 12) has a continuously varying position along said longitudinal axis of the monofilament and the arrangement of each portion relative to the cross-section is constant along said longitudinal axis.

The invention also relates to a process of manufacturing monofilament, comprising drawing the monofilament from a rotating extrusion head.

### FIELD OF THE INVENTION

The invention relates to a cutting monofilament for a vegetation cutting machine such as a brush cutter or an edge trimmer and to a manufacturing process of such a monofilament.

### BACKGROUND OF THE INVENTION

In vegetation cutting machines, such as brush cutters or edge trimmers, a cutting monofilament is releasably attached to a cutting head and the cutting head is caused to rotate at a high speed by a motor.

In use, the monofilament tends to extend substantially radially from the cutting head due to centrifugal forces.

Such monofilaments are typically made of a synthetic material, preferably a thermoplastic material, usually belonging to the family of polyamides.

Several problems arise from the use of such monofilaments.

First, the monofilaments are subjected to high stress due to the impact with the vegetation to be cut and thus may present a limited durability, which causes the user to frequently replace the monofilament.

Besides, the rotation of the monofilament may generate an important noise, which is not comfortable for the user and the people in the surroundings.

U.S. Pat. No. 5,687,482 describes a twisted monofilament intended to reduce the noise level. Such a monofilament has a constant polygonal cross-section whose position varies continuously along the longitudinal axis of the monofilament. Said monofilament is manufactured using an extrusion machine comprising a die having the same cross-section as the monofilament. The monofilament is drawn from said die and then twisted and deformed in a permanent way by heating. Said monofilament is made of a single material.

In addition, it may be useful to use different materials in the monofilament in order to benefit from the specific mechanical properties of each material, e.g. to improve at the same time flexibility and durability of the monofilament.

When different materials are used as a mixture, it is difficult to obtain a good homogeneity of the mixture, in particular due to the different configurations and lengths of the polymer chains of each material.

Hence, the monofilament obtained from such a mixture may not have homogeneous mechanical properties and thus a variable cutting efficiency depending on the considered position along its longitudinal axis.

### BRIEF DESCRIPTION OF THE INVENTION

A goal of the invention is thus to provide a monofilament that comprises at least two materials and that ensures that the mechanical properties of the monofilament are substantially identical whatever the position along the longitudinal axis of the monofilament.

To that end, a first object of the invention is a cutting monofilament for a vegetation cutting machine such as a brush cutter or an edge trimmer, having a cross-section comprising at least two portions made of thermoplastic materials having different mechanical properties, said cross-section being constant along a longitudinal axis of the monofilament, wherein each of said portions has a continuously varying position along said longitudinal axis of the monofilament and the arrangement of each portion relative to the cross-section is constant along said longitudinal axis.

By monofilament is meant a filament formed of a single thread and not an assembly of several fibers.

Color variation of a thermoplastic material is not considered to alter the mechanical properties of the material. In other words, if two portions of a monofilament are made of the same material but only differ by the color of the material, they are considered to be made of materials having different chemical compositions but the same mechanical properties.

According to an embodiment, the cross-section comprises at least three portions arranged side by side within the cross-section of the monofilament.

The limit between two adjacent portions in the cross-section of the monofilament may be substantially linear.

According to an embodiment, the position of each portion of the cross-section varies relative to the longitudinal axis of the monofilament by a constant angle by unit of length of the monofilament.

The period of variation of the position of each portion of the cross-section relative to the longitudinal axis of the monofilament is typically greater than 40 mm.

According to an embodiment, the cross-section has a polygonal shape comprising from four to eight edges.

For example, the monofilament has a square cross-section and the portions are arranged so as to form respective stripes parallel to a side of the cross-section.

Such a monofilament is twisted along its longitudinal axis and the angle of variation of the position of each portion of the cross-section is equal to the twisting angle of the monofilament.

According to another embodiment, the cross-section has a round shape.

Typically, the area of the cross-section of the monofilament is equal to the cross-section of a round monofilament having a diameter comprised between 1.35 and 4 mm.

Advantageously, at least one of the portions comprises a polyamide or a copolyamide.

According to an embodiment, a portion of the cross-section comprises PA 6/6 and another portion of the cross-section comprises PA 6-6/6.

According to an embodiment, a portion of the cross-section comprises polylactic acid (PLA) or a mixture comprising a polyamide, a polyolefin and a prodegradant agent including a stearate of a transition metal.

According to an embodiment, at least one portion of the cross-section comprises aramid or para-aramid polymer particles.

According to a second aspect, the invention provides a process of manufacturing such a monofilament.

Said process comprises:
providing a rotating extrusion head comprising a die having the same cross-section as the monofilament and causing said die to rotate;
feeding said extrusion head with a respective material of each of the portions of the cross-section of the monofilament, through respective inlets so as to arrange, in a cross-section of the die, said portions of the cross-section of the monofilament;
drawing the monofilament from said die, the rotation of the die causing the position of each portion of the cross-section to vary continuously along the longitudinal axis of the monofilament.

### BRIEF DESCRIPTION OF THE DRAWINGS

Additional features and advantages of the invention will be apparent from the detailed description that follows, in reference with appended drawings wherein:

FIGS. 1A and 1B show a perspective view of an embodiment of a cutting monofilament according to the invention having a square cross-section;

FIGS. 2A and 2B show a perspective view of an embodiment of a cutting monofilament according to the invention having a round cross-section.

### DETAILED DESCRIPTION OF THE INVENTION

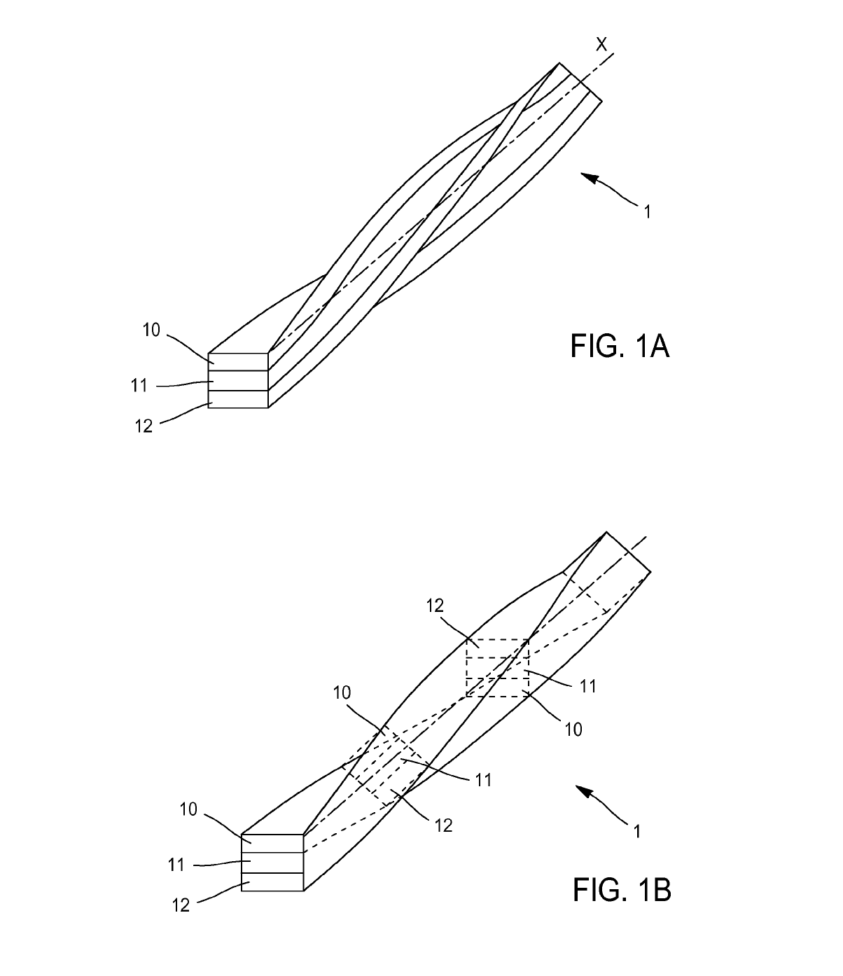

FIGS. 1A and 1B illustrates a cutting monofilament 1 according to an embodiment of the invention. FIG. 1A shows the outer surface of the monofilament while FIG. 1B comprises sectional views showing different positions of the cross-section along the longitudinal axis X.

In FIGS. 1A and 1B, the monofilament has a square cross-section but the invention more generally encompasses polygonal cross-sections having more than four edges, preferably having from four to eight edges. For example, the cross-section may have a star shape, a pentagonal shape, a hexagonal shape.

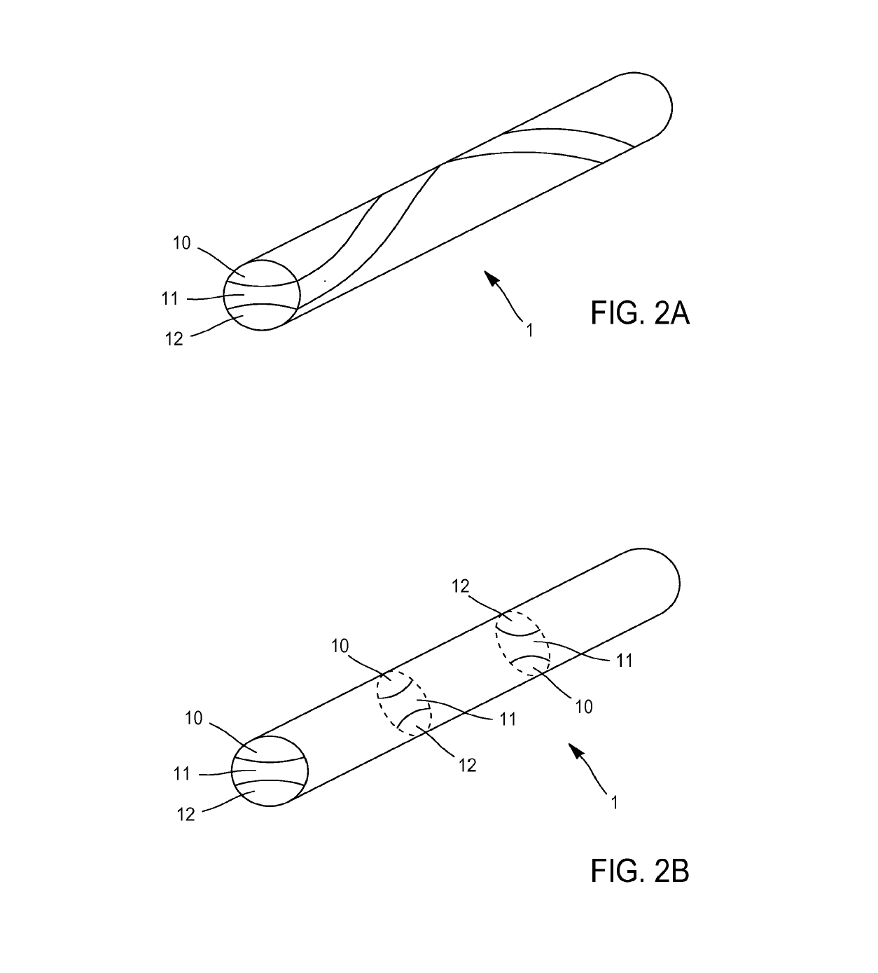

FIG. 2 illustrates a cutting monofilament 1 according to another embodiment of the invention, said monofilament having a round cross-section. FIG. 2A shows the outer surface of the monofilament while FIG. 2B comprises sectional views showing different positions of the cross-section along the longitudinal axis X.

A polygonal cross-section may be preferred due to the presence of the edges that improve the cutting efficiency of the monofilament for dry vegetation; a round cross-section may usually be preferred to cut fleshy vegetation.

As shown in FIGS. 1A-1B and 2A-2B, the cross-section of the monofilament comprises three portions 10, 11, 12 that are arranged side by side so as to form parallel stripes.

Preferably, when the cross-section is square as shown in FIGS. 1A-1B, said stripes are parallel to a side of the square. In this way, it is possible to provide to said side and to the opposite side different materials and thus different mechanical properties.

These stripes may have the same width (i.e. each portion has a width that is equal to ⅓ of the width of the cross-section); otherwise, the stripes may have different widths—for example, the central portion 11 may be wider than the two outer portions 10, 12.

At least two of portions 10, 11, 12 are made of different thermoplastic materials, i.e. materials having different mechanical properties.

For example, each portion 10, 11, 12 is made of a material different from the material of each other portion.

Alternatively, one portion (e.g. the central portion 11) may be made of a first material and the two other portions (e.g. portions 10 and 12 that are arranged on both sides of portion 11) are both made of a second material that is different from the first one.

Usually, cutting monofilaments are made of polyamide (i.e. a homopolymer) or copolyamide (i.e. a copolymer).

The material of each portion can thus typically be selected from polyamides (e.g. PA 6, PA 6/6, PA 6/12 or PA 6/11) and copolyamides (e.g. PA 6-6/6), possibly reinforced by a suitable filler.

The material of each portion may be selected based on the desired properties to be imparted to the respective portion.

For example, to impart flexibility to a given portion, PA 6-6/6 (which is a copolymer) may be preferred, whereas PA 6/6 (which is a homopolymer) may be preferred in view of increasing hardness and durability to the respective portion.

The structure of the monofilament can thus be adjusted for optimizing the properties of the cutting monofilament.

According to an embodiment, the monofilament comprises a central portion made of an oxo-biodegradable material, such as a composition comprising a polyamide, a polyolefin, a prodegradant agent and a compatibilization agent, as described in patent application EP 2 492 304 in the name of the Applicant, and two outer portions made of PA6 or PA6-6/6. In the oxo-biodegradable composition, the polyolefin comprises advantageously low-density polyethylene (LDPE). The prodegradant agent comprises advantageously a stearate of a transition metal, e.g. iron stearate, manganese stearate and/or cobalt stearate. The composition advantageously also comprises a compatibilization agent to provide compatibility of the polyamide and the polyolefin. The weight proportions of such a composition are: from 50 to 70% of polyamide, from 20 to 40% of polyolefin, from 2 to 10% of the prodegradant agent and from 0.2 to 2% of the compatibilization agent. Such a monofilament has oxo-biodegradability properties due to the material of the central portion but the outer portions have better mechanical properties than the central portion. Hence, the outer portions protect the central portion and also improve the cutting efficiency.

According to another embodiment, the monofilament comprises a central portion made of polylactic acid (PLA), and two outer portions made of PA6 or PA6-6/6. In this way, the main part of the monofilament has biodegradability properties (PLA being degradable under the action of water and/or enzymes) but the outer portions have better mechanical properties than the central portion.

According to another embodiment, the monofilament comprises a central portion made of a mixture of a polyamide and a polyolefin (e.g. a mixture of PA6 and PEHD) with less than 50% by weight of polyolefin including a compatibilization agent as described in patent application WO 2009/124593 in the name of the Applicant, and two outer portions made of PA6 or PA6-6/6 having greater mechanical properties than the central portion.

In addition, at least one of the portions may be made of a material reinforced by a filler, such as glass fibers, aramid or para-aramid polymer particles, or any other filler suitable for reinforcing the monofilament. For example, suitable para-aramid particles are sold by DuPont de Nemours under the name “Kevlar” (registered trade mark).

Indeed, as described in U.S. Pat. No. 6,171,697 in the name of the Applicant, the incorporation of a small amount of aramid or para-aramid polymer particles, this amount possibly representing between 0.5% and 5% of the total mass, into a polyamide or copolyamide cutting filament effectively prevents the phenomenon of the line sticking in the cutting head. The incorporation of such particles also significantly increases the abrasion and wear resistance of the cutting filament, as has been demonstrated by tests which have shown a reduction of the order of at least 15% in the weight loss of the filament, compared with conventional cutting filament, under the same operating conditions.

The area of the cutting monofilament is typically equal to the area of a round monofilament having a diameter between 1.35 and 4 mm.

The cross-section of the monofilament is constant, meaning that in any position along the longitudinal axis of the monofilament, the cross-section has the same shape and dimensions and the portions 10, 11 and 12 are distributed within the cross-section in an identical way.

However, the position of each portion of the cross-section varies continuously along the longitudinal axis of the monofilament. In other words, each portion describes a helical path along of the longitudinal axis of the monofilament (see FIG. 1B and FIG. 2B).

According to an embodiment, the position of each portion of the cross-section varies relative to the longitudinal axis of the monofilament by a constant angle by unit of length of the monofilament.

The period of variation of the position of each portion of the cross-section relative to the longitudinal axis of the monofilament (i.e. the minimal distance according to the longitudinal axis between two cross-sections where each portion has the same position relative to the longitudinal axis) is typically greater than 40 mm.

Such a configuration of the monofilament may be obtained by using a rotating extrusion head comprising a die having the same cross-section as the monofilament. By same cross-section is meant that the cross-section of the die has the same shape as the cross-section of the monofilament. The dimension of the die cross-section may however be greater than the dimension of the monofilament cross-section in order to take into account a possible stretching of the monofilament after drawing it from the extrusion head.

The manufacturing process is the following.

The die is caused to rotate within the extrusion head.

The extrusion head is fed with a respective material of each of said at least two portions through at least two respective inlets so as to arrange, in a cross-section of the die, said at least two portions of the cross-section of the monofilament. The inlets are controlled in parallel to supply the different materials to the extrusion head.

The monofilament is then drawn from said die, the rotation of the die causing the position of each of said at least three portions to vary continuously along the longitudinal axis of the monofilament.

The monofilament may then be stretched, which has the effect of reducing the dimension of the cross-section of the final monofilament as compared to the dimension of the die cross-section. For example, the die cross-section may be about 6 to 7 times greater than the dimension of the final cross-section of the monofilament.

When the monofilament has a polygonal (e.g. square) cross-section, the rotation of the die also has the effect of twisting the monofilament along its longitudinal axis.

In such case, the angle of variation of each of the at least three portions of the cross-section is equal to the twisting angle of the monofilament. This implies that if a portion is arranged along a side of the cross-section, it will always keep this arrangement with respect to the cross-section, whatever the position along the longitudinal axis of the monofilament. This ensures that in any position along the longitudinal axis, a given portion of the cross-section always has the same chemical composition and mechanical properties.

The use of a rotating extrusion head allows obtaining a twisted monofilament without requiring any process step after drawing the monofilament from the extrusion head. The manufacturing process is thus simpler than the one described in patent U.S. Pat. No. 5,687,482 and also avoids deforming the monofilament.

When the monofilament has a round cross-section, the rotation of the die does not affect the outer shape of the monofilament, which remains cylindrical, but also makes the position of the three portions vary along the longitudinal axis of the monofilament.

The period of variation of the position of each portion of the cross-section is determined by the rotation speed of the die: the speeder the die rotation the smaller the period of variation.

As compared to a monofilament made of a single mixture of different materials, the arrangement of portions made of different materials within the cross-section of the monofilament avoids the lack of homogeneity encountered with mixtures and thus allows more efficiently benefiting from the mechanical properties of each material. If necessary, adjacent portions may comprise a compatibilisation agent that promotes compatibility of the respective materials of said portions. The skilled person is able to select a suitable compatibilisation agent and to determine its proportion depending on the materials considered.

Although the monofilament of FIGS. 1A-1B and 2A-2B is illustrated with three portions, the invention encompasses embodiments comprising only two portions of different materials and embodiments comprising more than three portions of different materials.

The outer surface of the monofilament may also present striation along the longitudinal axis, that can be made after drawing the monofilament from the extrusion head.

### REFERENCES

U.S. Pat. No. 5,687,482

EP 2 492 304

WO 2009/124593

U.S. Pat. No. 6,171,697

1. A cutting monofilament for a vegetation cutting machine having a cross-section comprising at least three portions made of thermoplastic materials, each of said at least three portions having i) a width which extends from an outermost exterior edge to an opposing outermost exterior edge of the perimeter of said cross-section, and ii) a continuously varying position along the entire length of said longitudinal axis of the monofilament, wherein at least two of said portions made of thermoplastic materials have different mechanical properties and the at least three portions are arranged side by side within the cross-section of the monofilament.

2. The cutting monofilament of claim 1, wherein a boundary between two of said adjacent portions in the cross-section of the monofilament is substantially linear.

3. The cutting monofilament of claim 1, wherein the position of each portion of the cross-section varies relative to the longitudinal axis of the monofilament by a constant angle by unit of length of the monofilament.

4. The cutting monofilament of claim 4, wherein the period of variation of the position of each portion of the cross-section relative to the longitudinal axis of the monofilament is greater than 40 mm.

5. The cutting monofilament of claim 1, wherein the cross-section has a polygonal shape comprising from four to eight edges.

6. The cutting monofilament of claim 6, having a square cross-section, wherein the portions are arranged so as to form respective stripes parallel to a side of the cross-section.

7. The cutting monofilament of claim 6, wherein the cutting monofilament is twisted along its longitudinal axis and the angle of variation of the position of each portion of the cross-section is equal to the twisting angle of the monofilament.

8. The cutting monofilament of claim 1, wherein the cross-section has a round shape.

9. The cutting monofilament of claim 1, wherein the area of the cross-section of the monofilament is equal to the cross-section of a round monofilament having a diameter comprised between 1.35 and 4 mm.

10. The cutting monofilament of claim 1, wherein at least one of the portions comprises a polyamide or a copolyamide.

11. The cutting filament of claim 1, wherein a portion of the cross-section comprises PA 6/6 and another portion of the cross-section comprises PA 6-6/6.

12. The cutting monofilament of claim 1, wherein a portion of the cross-section comprises polylactic acid (PLA) or a mixture comprising a polyamide, a polyolefin and a prodegradant agent including a stearate of a transition metal.

13. The cutting monofilament of claim 1, wherein at least one portion of the cross-section comprises aramid or para-aramid polymer particles.

14. A process of manufacturing the cutting monofilament of claim 1, comprising:
providing a rotating extrusion head comprising a die having the same cross-section as the monofilament and causing said die to rotate;
feeding said extrusion head with a respective material of each of the portions of the cross-section of the monofilament, through respective inlets so as to arrange, in a cross-section of the die, said portions of the cross-section of the monofilament;
drawing the monofilament from said die, the rotation of the die causing the position of each portion of the cross-section to vary continuously along the longitudinal axis of the monofilament.

15. A cutting monofilament for a vegetation cutting machine having a cross-section comprising at least two portions made of thermoplastic materials having different mechanical properties, each of said at least two portions having i) a width which extends from an outermost exterior edge to an opposing outermost exterior edge of the perimeter of said cross-section, and ii) a continuously varying position along the entire length of said longitudinal axis of the monofilament and the arrangement of each portion relative to the cross-section is constant along said longitudinal axis, wherein the monofilament has a square cross-section and the at least two portions are arranged so as to form respective stripes parallel to a side of the cross-section and have a length which extends from a first end of said cross-section to an opposite end of said cross-section.

16. A cutting monofilament for a vegetation cutting machine having a rectangular cross-section comprising at least three portions made of thermoplastic materials having different mechanical properties, each of said at least three portions having i) a width which extends from an outermost exterior edge to an opposing outermost exterior edge of the perimeter of said cross-section, and ii) a continuously varying position along the entire length of said longitudinal axis of the monofilament and the arrangement of each portion relative to the cross-section is constant along said longitudinal axis, wherein the monofilament has a polygonal shape comprising from four to eight edges and the at least three portions are arranged so as to form respective parallel stripes and have a length which extends from a first end of said cross-section to an opposite end of said cross-section.
